(19) United States
(12) Patent Application Publication
(10) Pub. No.: US 2017/0306186 A1
(43) Pub. Date: Oct. 26, 2017

(54) POLYVINYL CHLORIDE ADHESIVE TAPE

(71) Applicant: Yazaki Corporation, Tokyo (JP)

(72) Inventors: Hiroshi ICHIKAWA, Shizuoka (JP); Kazuya TAKEUCHI, Shizuoka (JP)

(73) Assignee: Yazaki Corporation, Tokyo (JP)

(21) Appl. No.: 15/491,115

(22) Filed: Apr. 19, 2017

(30) Foreign Application Priority Data
Apr. 20, 2016 (JP) 2016-084198

(51) Int. Cl. C09J 7/02; C09J 107/00; H01B 7/00; C09J 133/00

(52) U.S. Cl. CPC C09J 7/0278; C09J 133/00; C09J 107/00; H01B 7/0045; C09J 2407/00; C09J 2203/302; C09J 2427/006; C09J 2433/00; C09J 2475/003; C09J 2407/003

(57) ABSTRACT

A polyvinyl chloride adhesive tape includes a substrate, a primer layer, and an adhesive layer. The substrate contains a polyvinyl chloride and a plasticizer. The primer layer is disposed under the substrate. The adhesive layer is disposed under the primer layer and contains a resin component having 20% by mass or more of acrylic polymer. The plasticizer contained in the substrate is at least one plasticizer selected from the group consisting of trimellitic acid-based plasticizers, aliphatic dibasic acid-based plasticizers, epoxy-based plasticizers, phthalic acid-based plasticizers, pyromellitic acid ester-based plasticizers, phosphate ester-based plasticizers, and ether ester-based plasticizers.

### CROSS REFERENCE TO RELATED APPLICATIONS

This application claims the priority of Japanese Patent Application No. 2016-084198, filed on Apr. 20, 2016, the entire content of which are incorporated herein by reference.

### BACKGROUND

### Technical Field

The present invention relates to a polyvinyl chloride adhesive tape.

Specifically, the present invention relates to polyvinyl chloride adhesive tape which is resistant to heat discoloration and hydrolysis.

### Related Art

Having electrical insulation and waterproofness, polyvinyl chloride adhesive tape is used, for example, to cover an electrical wire or to bind wires in a wire harness. When used in places such as an engine compartment of an automobile, however, the polyvinyl chloride adhesive tape is prone to discolor due to repeated exposure to the high temperature environment. For a high-voltage circuit, in particular, there has been a demand for polyvinyl chloride adhesive tapes having high heat discoloration resistance, because the tape has to maintain orange color under the SAE Standard to make the high-voltage circuit distinguishable from other circuits.

JP 2000-345121 discloses a polyvinyl chloride adhesive tape which includes: a substrate made of a polyvinyl chloride resin; and an adhesive layer made of an adhesive. Specifically, J P 2000-345121 discloses the polyvinyl chloride adhesive tape in which: a plasticizer used in the polyvinyl chloride resin is a polyester-based plasticizer; and a primer layer made of urethane-based latex is provided between the substrate and the adhesive layer.

### SUMMARY

In a high-temperature and high-humidity environment, however, the polyvinyl chloride adhesive tape of JP 2000-345121 is not durable for a long period. Thus, there remains a demand for polyvinyl chloride adhesive tape which can achieve higher durability even in a high-temperature and high-humidity environment.

The present invention has been made in view of the foregoing problems of the convention technique. An object of the present invention is to provide a polyvinyl chloride adhesive tape which is resistant to heat discoloration and hydrolysis.

A polyvinyl chloride adhesive tape according to a first aspect of the present invention includes a substrate, a primer layer, and an adhesive layer. The substrate contains a polyvinyl chloride and a plasticizer. The primer layer is disposed under the substrate. The adhesive layer is disposed under the primer layer and contains a resin component having 20% by mass or more of acrylic polymer. The plasticizer contained in the substrate is at least one plasticizer selected from the group consisting of trimellitic acid-based plasticizers, aliphatic dibasic acid-based plasticizers, epoxy-based plasticizers, phthalic acid-based plasticizers, pyromellitic acid ester-based plasticizers, phosphate ester-based plasticizers, and ether ester-based plasticizers.

The primer layer may contain a resin component having 90% by mass or more of natural rubber.

The substrate may contain 40 to 70 parts by mass, inclusive, of the plasticizer relative to 100 parts by mass of the polyvinyl chloride.

A wire harness according to a second aspect of the present invention includes the polyvinyl chloride adhesive tape according to the first aspect.

An aspect of the present invention provides a polyvinyl chloride adhesive tape which is resistant to heat discoloration and hydrolysis.

### BRIEF DESCRIPTION OF DRAWINGS

FIG. 1 is a cross-sectional view of a polyvinyl chloride adhesive tape according to an embodiment of the present invention.

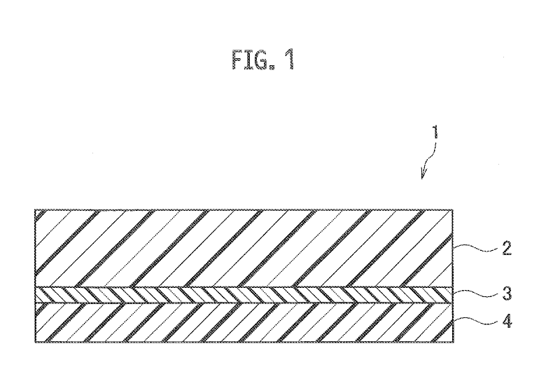

### DETAILED DESCRIPTION

Using the drawings, detailed descriptions will be hereinbelow provided for a polyvinyl chloride adhesive tape of an embodiment. Incidentally, dimensional ratios in the drawings are exaggerated for the sake of explanatory convenience, and are thus different from the actual ratios in some cases.

A polyvinyl chloride adhesive tape 1 of the embodiment includes: a substrate 2 containing plasticizers and polyvinyl chloride; a primer layer 3 disposed under the substrate 2; and an adhesive layer 4 disposed under the primer layer 3.

### (Substrate)

The substrate 2 contains a plasticizer(s) and a polyvinyl chloride. The polyvinyl chloride is an economical and easy-to-process material with high heat resistance and electrical insulation. Furthermore, the polyvinyl chloride can be made more flexible by the addition of the plasticizer(s). The plasticizer(s) can weaken intermolecular forces by entering interstices between polyvinyl chloride molecules, and thereby can make polyvinyl chloride more flexible.

Polyvinyl chloride is a polymer of vinyl chloride monomer. The usable polyvinyl chloride is not particularly limited, but may be rigid polyvinyl chloride or soft polyvinyl chloride. In other words, the polyvinyl chloride may be not only vinyl chloride homopolymer but also a copolymer of vinyl chloride with other monomers. The other monomers are not particularly limited, but at least one selected from the group consisting of vinyl acetate, chloroethylene, acrylonitrile, ethylene, propylene, styrene, acrylate, isobutylene, butadiene and isoprene may be used.

The average degree of polymerization of the polyvinyl chloride used for the substrate is not particularly limited, but is preferably 800 to 2000, and more preferably 1000 to 1500. When the average degree of polymerization is 800 or more, abrasion to the substrate can be inhibited. Meanwhile, when the average degree of polymerization is 2000 or less, an increase in the melt viscosity of the polyvinyl chloride can be inhibited, and the forming processability of the polyvinyl chloride can be enhanced. Incidentally, polyvinyl chlorides whose respective polymerization degrees are in the above-mention range may be used singly or in combination of two or more thereof The average degree of polymerization can be calculated in accordance with Japanese Industrial Standards (JIS) K6720-2:1999 (Plastics—Homopolymer and copolymer resins of vinyl chloride—Part 2: Preparation of test samples and determination of properties).

The plasticizer(s) is at least one selected from the group consisting of trimellitic acid-based plasticizers, aliphatic dibasic acid-based plasticizers, epoxy-based plasticizers, phthalic acid-based plasticizers, pyromellitic acid ester-based plasticizers, phosphate ester-based plasticizers and ether ester-based plasticizers. When these plasticizers are contained in the substrate 2, it is possible to obtain the polyvinyl chloride adhesive tape 1 with high hydrolysis resistance. Incidentally, it may be conceived that as the plasticizers, polyester-based plasticizers may be used for the substrate. The use of polyester-based plasticizers for the substrate, however, decreases the hydrolysis resistance of the polyvinyl chloride adhesive tape. With this taken into consideration, the polyester-based plasticizers are not used in the embodiment, One may consider that the reason for the decrease in the hydrolysis resistance of the polyvinyl chloride adhesive tape due to the use of the polyester-based plasticizers is that multiple ester bonds contained in the main chain make polyester-based plasticizers easy to hydrolyze. In this respect, the polyester-based plasticizers are plasticizers which contain repeated ester structures in the main chain.

As the trimellitic acid-based plasticizers, trimellitates may be used. Incidentally, trimellitates are esters derived from trirnellitic acid and alcohols by dehydration condensation. Examples of the alcohols for use in the trimellitates include aliphatic alcohols having 8 to 13 carbon atoms. These alcohols may be used singly or in combination of two or more thereof. Examples of the trimellitates for use include trioctyl trimellitate (TOTM) and triisodecyl trimellitate.

The aliphatic dibasic acid-based plasticizers are at least one selected from the group consisting of adipic acid esters, sebacic acid esters, azelaic acid esters. Incidentally, these esters are derived from the acids and alcohols by dehydration condensation. Examples of the alcohols for use in these esters include aliphatic alcohols having 3 to 13 carbon atoms. These alcohols may be used singly or in combination of two or more thereof. As aliphatic plasticizers, at least one selected from the group consisting of dioctyl adipate (DOA), di-isononyl adipate (DINA), dibutyl sebacate (DBS), dioctyl sebacate (DOS), dioctyl azelate (DOZ) may be used.

As the epoxy-based plasticizers, at least one selected from the group consisting of epoxidized soybean oil (ESO), epoxidized linseed oil (ELO), epoxidized octyl stearate, butyl epoxidized fatty acid, epoxidized linseed oil fatty acid butyl may be used.

Examples of the phthalic acid-based plasticizers are phthalic esters.

Incidentally, phthalic esters are esters derived from phthalic acid and alcohols by dehydration condensation. Examples of the alcohols for use in the phthalic esters include aliphatic alcohols having 8 to 13 carbon atoms. These alcohols may be used singly or in combination of two or more thereof. As the phthalic acid-based plasticizers, at least one selected from the group consisting of di(2-ethyl hexyl) phthalate (DEHP), di-n-octyl phthalate (DnOP), diisononyl phthalate (DINP), dinonyl phthalate (DNP), diisodecyl phthalate (DIDP) and ditridecyl phthalate may be used.

As the pyromellitic acid ester-based plasticizers, pyromellitic acid esters may be used. Incidentally, pyromellitic acid esters are esters derived from pyromellitic acid and alcohols by dehydration condensation, Examples of the alcohols for use in the pyromellitic acid esters include aliphatic alcohols having 8 to 13 carbon atoms. These alcohols may be used singly or in combination of two or more thereof. Examples of the pyromellitic acid esters include tetraoctyl pyromellitate and tetraisodecyl pyromellitate.

As the phosphate ester-based plasticizers, phosphate esters may be used. Incidentally, the phosphate esters include esters derived from phosphoric acid and alcohols by dehydration condensation, and esters derived from phosphoric acid and phenols by dehydration condensation. In alcohols and phenols for use in the phosphate esters, the number of carbon atoms needs to be one or greater but not greater than 14. These alcohols and phenols may be used singly or in combination of two or more thereof. Examples of the phosphate esters include tricresyl phosphate (TCP), triphenyl phosphate (TPP), tri-2-ethylhexyl phosphate (TOP), trixylenyl phosphate (TXP) and triethyl phosphate (TEP).

As the ether ester-based plasticizers, plasticizers containing ether bonds or ester bonds may be used. Examples of the ether ester-based plasticizers include diethylene glycol diacetate, triethylene glycol diacetate and diethylene glycol dibenzoate.

The substrate preferably contains 40 to 70 parts by mass, inclusive, of the plasticizer(s) relative to 100 parts by mass of the polyvinyl chloride. The substrate containing 40 parts by mass or more of the plasticizer(s) makes it possible to increase the flexibility of the polyvinyl chloride adhesive tape 1. Meanwhile, the substrate containing 70 parts by mass or less of the plasticizer(s) makes it possible to increase the tensile strength of the polyvinyl chloride adhesive tape 1.

The molecular weight of the plasticizer(s) is, but is not limited to, preferably 300 to 3000. The plasticizer(s) having a molecular weight of 300 or more makes it possible to increase the flexibility of the substrate. Meanwhile, the plasticizer(s) having a molecular weight of 3000 or less makes it possible to inhibit the plasticizer(s) from bleeding out. Incidentally, the molecular weight of the plasticizer(s) is more preferably 300 to 1500. The setting of the molecular weight of the plasticizer(s) in this range makes it possible to more effectively inhibit the plasticizer(s) from bleeding out.

The thickness of the substrate 2 is not particularly limited, but is usually 30 μm to 200 μm, and preferably 50 μm to 100 μm. The substrate 2 with a thickness 50 μm or more makes it possible to increase the tensile strength of the polyvinyl chloride adhesive tape 1. Meanwhile, the substrate 2 with a thickness of 100 μm or less makes it possible to inhibit the polyvinyl chloride adhesive tape 1 from wrinkling when the polyvinyl chloride adhesive tape 1 is wound around an electrical wire and the like.

### (Primer Layer)

The primer layer 3 is disposed under the substrate 2. In the embodiment, the placement of the primer layer 3 under the substrate 2 makes it possible to prevent components in the adhesive layer 4 from moving to the substrate 2, and thus to inhibit the polyvinyl chloride adhesive tape 1 from discoloring. Incidentally, the primer layer 3 may be disposed in contact with the lower surface of the substrate 2, or disposed under the substrate 2 with another layer provided in between.

The primer layer 3 preferably contains resin components. The resin components used in the primer layer 3 are not particularly limited, but at least one selected from the group consisting of natural rubbers, urethane polymers, acrylic polymers, ester polymers, epoxy polymers and synthetic rubbers may be used. Among these substances, a natural rubber and a urethane polymer are preferred to be used.

The natural rubber used for the primer layer 3 is obtained by: making incisions in the bark of a Hevea Brasiliensis tree; collecting the latex drawn off the tree; refining the latex into rubber; and solidifying and drying the rubber. The natural rubber mainly contains cis-1,4-polyisoprene. A grafted natural rubber obtained by grafting the natural rubber for example with a (meth)acrylic acid, styrene, acrylonitrile or the like may be also used for the primer layer 3.

Any urethane polymer may be used without imitation, as long as the urethane polymer contains urethane bonds. The urethane polymer can be obtained by the polyaddition reaction of polyisocyanates and polyols.

As the polyisocyanates, a least one selected from the group consisting of tolylene diisocyanate (TDI), diphenylmethane diisocyanate (MDI), hexamethylene diisocyanate (HDI), isophorone diisocyanate xylylene diisocyanate (XDI), hydrogenated xylylene diisocyanate (H6XDI), naphthalene diisocyanate (NDI), norbornene diisocyanate (NBDI) and hydrogenated diphenylmethane diisocyanate (H12MDI) may be used for example.

As the polyols, a least either polyether polyol or polyester polyol may be used for example. As the polyether polyol, a least one selected from the group consisting of polyethylene glycol, polypropylene glycol and polytetramethylene ether glycol may be used for example. As the polyester polyol, a least one selected from the group consisting of polyethylene adipate, polybutylene adipate, polyhexene adipate, polyethylene oxalate, polybutylene oxalate, polyhexene oxalate, polyethylene succinate, polybutylene succinate and polyhexene succinate may be used for example.

The primer layer 3 preferably contains a resin component containing 90% by mass or more of the natural rubber. The natural rubber content at 90% by mass or more makes it possible to inhibit the adhesive from remaining on the back surface of a roll of the polyvinyl chloride adhesive tape 1 when the tape is peeled off from the roll, even after the tape is stored in a high-temperature and high-humidity environment for a long time. In other words, the natural rubber content at 90% by mass or more is preferable since the content enhances the usability of the polyvinyl chloride adhesive tape 1. The primer layer 3 preferably contains 90% to 100% by mass, inclusive, of the natural rubber and 0% to 10%, inclusive, of the urethane polymer.

The thickness of the primer layer 3 is, but is not particularly limited to, usually 1 μm to 3 μm, and preferably 1 μm to 2 μm. The primer layer 3 with a thickness in this range makes it possible to obtain the polyvinyl chloride adhesive tape 1 with excellent adhesiveness and heat discoloration resistance.

### (Adhesive Layer)

The adhesive layer 4 is disposed under the primer layer 3. The adhesive layer 4 may be disposed in contact with the lower surface of the primer layer 3, or disposed under the primer layer 3 with another layer provided in between.

The adhesive layer 4 contains resin components containing an acrylic polymer. An acrylic polymer is a polymer obtainable by polymerizing (meth)acrylic acid ester monomers. In this specification, the (meth)acrylic acid esters mean acrylic acid esters or methacrylic acid esters. The (meth)acrylic acid esters are derived from (meth)acrylic acids and alcohols by dehydration condensation. Examples of the alcohols for use in the (meth)acrylic acid esters include aliphatic alcohols having 1 to 30 carbon atoms. Incidentally, alcohols preferable for use in the (meth)acrylic acid esters have 2 to 20 carbon atoms. In addition, these alcohols may be used singly or in combination of two or more thereof.

As the (meth)acrylic acid esters, at least one selected from the group consisting of methyl (meth)acrylate, ethyl (meth)acrylate, propyl (meth)acrylate, butyl (meth)acrylate, 2-ethylhexyl (meth)acrylate, isononyl (meth)acrylate, isobornyl (meth)acrylate, glycidyl (meth)acrylate, stearyl (meth)acrylate, lauryl (meth)acrylate and eicosyl (meth)acrylate may be used for example.

The acrylic polymer may be a copolymer obtained by copolymerization of a (meth)acrylic acid ester monomer and different monomers. As the different monomers, at least one selected from the group consisting of ethylene, propylene, styrene, vinyl chloride, vinylidene chloride, acrylonitrile and acrylamide may be used for example.

Any resin components may be used without limitation in the adhesive layer 4, as long as the resin components contain the acrylic polymer. Nevertheless, the adhesive layer 4 may further contain at least one selected from the group consisting of urethane polymers, ester polymers, epoxy polymers, natural rubbers, synthetic rubbers, tackifying resins and antioxidants. Among them, a natural rubber is most preferably used. Furthermore, a tackifying resin is also preferably used to increase the adhesiveness of the adhesive layer 4. Moreover, an antioxidant is also preferably used to prevent deterioration in the adhesive component in the adhesive layer 4.

The natural rubber usable in the adhesive layer 4 is the same as that used in the primer layer 3. In other words, the natural rubber used for the adhesive layer 4 is obtained by: making incisions in the bark of a Hevea Brasiliensis tree; collecting the latex drawn off the tree; refining the latex into rubber; and solidifying and drying the rubber. The natural rubber mainly contains cis-1,4-polyisoprene. A grafted natural rubber obtained by grafting the natural rubber for example with a (meth)acrylic acid, styrene, acrylonitrile or the like may be also used for the adhesive layer 4.

The tackifying resins usable for the adhesive layer 4 are not particularly limited, but any tackifying; resins which can increase the adhesiveness of the adhesive layer 4 may be used. As the tackifying resins, at least one selected from the group consisting of rosin esters, terpene phenols and rosin resins may be used.

The antioxidants usable for the adhesive layer 4 are not particularly limited, but any antioxidants which can prevent the deterioration in the adhesive component in the adhesive layer 4 may be used. As the antioxidants, at least one selected from the group consisting of phenolic antioxidants, aminic antioxidants, phosphoric antioxidants, sulfuric antioxidants and hydrazine antioxidant may be used.

The adhesive layer 4 contains a resin component containing 20% by mass or more of acrylic polymers. The acrylic polymers content at 20% by mass or more makes it possible to inhibit the polyvinyl chloride adhesive tape 1 from discoloring even in a high-temperature environment such as in an engine compartment. Incidentally, the adhesive layer 4 preferably contains 0% to 20% by mass, inclusive, of the natural rubber and 20% to 40% by mass, inclusive, of the acrylic polymers. Furthermore, the adhesive layer 4 preferably contains 0% to 20% by mass, inclusive, of the natural rubber, 40% to 60% by mass, inclusive, of the tackifying resins, and 20% to 40% by mass, inclusive, of the acrylic polymers.

The thickness of the adhesive layer 4 is not particularly limited, but is usually 5 μm to 40 μm and preferably 10 μm to 30 μm. The adhesive layer 4 with a thickness in this range makes it possible to obtain the polyvinyl chloride adhesive tape 1 with excellent adhesiveness.

The polyvinyl chloride adhesive tape 1 of the embodiment can be used to cover an electrical wire, bind wires in a wire harness, or do the like. With such application, the electrical wire and the wire harness can be protected. Such use also makes it possible to form a bundle of electrical wires.

The thickness of the polyvinyl chloride adhesive tape 1 is not particularly limited, but is usually 35 μm to 240 μm, and preferably 60 μm to 130 μm. A thickness 60 μm or more makes it to obtain the polyvinyl chloride adhesive tape 1 having excellent tensile strength. Meanwhile, a thickness of 130 μm or less makes it possible to inhibit the polyvinyl chloride adhesive tape 1 from wrinkling when the polyvinyl chloride adhesive tape 1 is wound around an electrical wire and the like.

As discussed above, the polyvinyl chloride adhesive tape 1 of the embodiment includes: the substrate 2 containing the plasticizer(s) and the polyvinyl chloride; the primer layer 3 disposed under the substrate 2; and the adhesive layer 4 disposed under the primer layer 3. The plasticizer(s) is at least one selected from the group consisting of trimellitic acid-based plasticizers, aliphatic dibasic acid-based plasticizers, epoxy-based plasticizers, phthalic acid-based plasticizers, pyromellitic acid ester-based plasticizers, phosphate ester-based plasticizers and ether ester-based plasticizers. Meanwhile, the adhesive layer 4 contains a resin component containing 20% by mass or more of acrylic polymers. This makes increases the heat discoloration resistance and the hydrolysis resistance of the polyvinyl chloride adhesive tape 1 of the embodiment.

### (Wire Harness)

A wire harness of the embodiment includes the above-discussed polyvinyl chloride adhesive tape 1. The above-discussed polyvinyl chloride adhesive tape 1 has the excellent heat discoloration resistance and the excellent hydrolysis resistance. Thus, multiple wires bound together with the polyvinyl chloride adhesive tape 1 wound therearound can be preferably use, for example, as a wire harness for automobiles.

### Examples

Using examples and comparative examples, detailed descriptions will be hereinbelow provided for the embodiment. It should be noted, however, that the embodiment is not limited to the examples.

### (Preparation of Samples for Examples and Comparative Examples)

For each of the examples and the comparative examples, a 70 μm-thick substrate was prepared by: putting the materials of the substrate shown in the following tables into a heating roller; and calendaring the resultant material. Thereafter, a priming agent solution was prepared by diluting the materials of a priming agent shown in the following tables with water such that a nonvolatile content was 30% by mass. A primer layer was prepared by: applying the solution to the substrate using a bar coater such as the thickness of the prime layer as dried became equal to 1 to 3 μm; and drying the solution at 100° C. for three minutes. Subsequently, another solution was prepared by diluting the materials of an adhesive layer shown in the following tables with water such that a nonvolatile content was 55% by mass. The adhesive layer was prepared by: applying the solution to the dried primer layer using a bar coater such as the thickness of the adhesive layer as dried became equal to 20 μm; and drying the solution at 100° C. for three minutes. The thus-obtained sheet of polyvinyl chloride adhesive tape was wound around a winding core into a roll of polyvinyl chloride adhesive tape. Incidentally, the roll was cut into a width of 19 mm. Thereafter, the roll of polyvinyl chloride adhesive tape was evaluated.

### (Substrate)

Polyvinyl chloride: PCV compound made by Shin-Etsu. Chemical Co.; Ltd.
Polyester-based plasticizer: Adipic acid polyester (D643D with a molecular weight of 2000) made by J-Plus Co., Ltd.
Trimellitic acid-based plasticizer: trimellitic acid tris(2-ethylhexyl) (TOTM with a molecular weight of 500) made by J-Plus Co., Ltd.
Aliphatic dibasic acid-based plasticizer: a Sanso Cizer (Registered Trademark) (with a molecular weight of 2000) made by New Japan Chemical Co., Ltd,
Epoxy-based plasticizer: an XG (with a molecular weight of 3000) made by Toagosei Co., Ltd.
Phthalic acid-based plasticizer: Diisononyl phthalate (DINP with a molecular weight of 300) made by J-Plus Co., Ltd.

### (Primer Layer)

Natural rubber: Natural Rubber made; by Unimac Ltd,
Urethane polymer: Urethane emulsion made by Regitex Co., Ltd.

### (Adhesive Layer)

Natural rubber: Natural Rubber made by Unimac Ltd.
Acrylic polymer: Acrylic emulsion made by Regitex Co., Ltd.
Tackifying resin: E-726 made by Arakawa Chemical Industries, Ltd.
Antioxidant: IRGANOX (Registered Trademark) 1010 made by BASF SE

### (Evaluation)

### (Heat Discoloration Resistance)

For each of the examples and comparative examples, an approximately 15-cm length of polyvinyl chloride adhesive tape was cut from the roll, and was attached to a PET film (a Mylar sheet) to prepare a test piece. The test sheet was put into a thermostatic testing machine inside which the temperature had been set at 120° C. 240 hours later, the test piece was taken out of the testing machine, and the level of discoloration of the test piece was checked visually. A test piece which had not discolored was rated with ∘ (excellent); a test piece which had slightly discolored was rated with Δ (fairly good); and a test piece which had largely discolored was rated with x (poor).

### (Hydrolysis Resistance)

For each of the examples and comparative examples, a test sample was prepared by: cutting an approximately 30-cm length of polyvinyl chloride adhesive tape from the roll; winding the length of polyvinyl chloride adhesive tape around a polyvinyl chloride insulation electrical wire bundle including 19 electrical wires each with a conductor size of 0.5 sq. mm hound together; and winding the resultant polyvinyl chloride adhesive tape with the electrical wire bundle around a mandrel with a diameter of 80 mm once. The test sample was put into a pressure cooker testing machine (EHS-221M made by Espec Corporation) inside which the humidity at 100° C. had been set at 95%. One week later (168 hours later), the test sample was taken out of the testing machine, and it was checked whether cracks and fractures were in the tape. A test piece which had not cracked or broken was rated with ∘; a test piece which had slightly cracked and/or broken was rated with Δ; and a test piece which had largely cracked and/or broken was rated with x.

### (Movement to Back Surface)

For each of the examples and comparative examples, the roll of polyvinyl chloride adhesive tape was put into a pressure cooker testing machine inside which the relative humidity (RH) at 65° C. had been set at 93%. One week later (168 hours later), the roll was taken out of the testing machine, and it was checked whether the adhesive layer remained on the back surface of the roll when the tape was peeled off the roll. A roll on whose back surface no part of the adhesive layer remained was rated with ∘; a roll on whose back surface a slight part of the adhesive layer remained was rated with Δ; and a roll on whose back surface much of the adhesive layer remained was rated with x.

### (Followability)

For each of the examples and comparative examples, an electrical wire bundle with a diameter of 10 mm was made by binding 19 electrical wires, and the tape was wound around the electrical wire bundle. Subsequently, it was checked whether the tape wrinkled. A tape which did not wrinkle was rated with ∘; a tape which slightly wrinkled was rated with Δ; and a tape which wrinkled because of its stiffness was rated with x.

### (Tape Strength)

For each of the examples and comparative examples, an electrical wire bundle with a diameter of 10 ram was made by binding 19 electrical wires, and the tape was wound around the electrical wire bundle. Subsequently, it was checked whether the tape fractured. A tape which did not fracture was rated with ∘; a tape which slightly fractured was rated with Δ; and a tape which fractured was rated with x.

### (Long-Term Heat Resistance)

For each of the examples and comparative examples, test pieces were obtained by cutting approximately 15-cm lengths of polyvinyl chloride adhesive tape from the roll, and were put into a temperature chamber with rotating specimen rack (GPH-102) made by Espec Corporation. 96 hours later, 216 hours later, 600 hours later, 960 hours later and 1440 hours later, the test pieces were taken out of the temperature chamber respectively. A tension test was performed on each test piece in order to measure the coefficient of extension of the test piece.

A tension testing machine (an Autograph AG-Xplus made by Shimadzu Corporation) was used for the tension test. The coefficient of extension of each test piece was measured according to the Method A under ITS Z0237 (Testing Methods of Pressure-sensitive Adhesive Tapes and Sheets). To put it specifically, a distance between the chucks in the tension testing machine was set at 100 mm; each test piece was stretched at a tension speed of 5 mm/sec; and how much the test piece extended before its breakage was measured. The coefficient of extension was calculated using an equation expressed as

E=((L₁−L₀)/L₀)×100

where: E is the coefficient of extension (%), L₀ is the distance between the chucks before the test began; and L₁ is the distance between the chucks at a time when the test piece broke.

The coefficient of extension of each test piece obtained by the tension test was entered into the Arrhenius equation to calculate a coefficient of extension which would have been obtained if the test piece had been stored at 80° C. or 100° C. for 10000 hours. A test piece was rated with ∘ in a case where the coefficient of extension of the test piece was calculated as 50% or more in the simulated 10000-hour storage, whereas a test piece was rated with ∘ in a case where the coefficient of extension of the test piece was calculated as less than 50% in the simulated 10000-hour storage.

### (Evaluation Results)

Results of evaluation based on the above-discussed evaluation methods are shown in Tables 1 to 4.

TABLE 1

| | | | | | Comparative | Comparative | Comparative | Comparative | Comparative |
|---|---|---|---|---|---|---|---|---|---|
| | | Example 1 | Example 2 | Example 3 | Example 1 | Example 2 | Example 3 | Example 4 | Example 5 |
| substrate | polyvinyl chloride | 100 | 100 | 100 | 100 | 100 | 100 | 100 | 100 |
| (parts by | polyester-based | — | — | — | — | — | — | 50 | 50 |
| mass) | trimellitic acid-based | 50 | 50 | 50 | 50 | 50 | 50 | — | — |
| | aliphatic dibasic acid-based | — | — | — | — | — | — | — | — |
| | epoxy-based | — | — | — | — | — | — | — | — |
| | phthalic acid-based | — | — | — | — | — | — | — | — |
| primer layer | natural rubber-based | 100 | 100 | 100 | 100 | 100 | — | 100 | — |
| (% by mass) | urethane-based | — | — | — | — | — | 100 | | 100 |
| adhesive | natural rubber-based | — | 10 | 20 | 30 | 40 | 40 | 40 | 40 |
| layer | tackifying resin | 55 | 55 | 55 | 55 | 55 | 55 | 55 | 55 |
| (% by mass) | acrylic | 40 | 30 | 20 | 10 | — | — | — | — |
| | antioxidant | 5 | 5 | 5 | 5 | 5 | 5 | 5 | 5 |
| properties | heat discoloration resistance | ∘ | ∘ | ∘ | x | x | x | x | ∘ |
| | hydrolysis resistance | ∘ | ∘ | ∘ | ∘ | ∘ | ∘ | x | x |
| | movement to back surface | ∘ | ∘ | ∘ | ∘ | ∘ | x | ∘ | x |
| | followability | ∘ | ∘ | ∘ | ∘ | ∘ | ∘ | ∘ | ∘ |
| | tape strength | ∘ | ∘ | ∘ | ∘ | ∘ | ∘ | ∘ | ∘ |
| | long-term heat resistance | ∘ | ∘ | ∘ | ∘ | ∘ | ∘ | ∘ | ∘ |
| | (80° C.) | | | | | | | | |
| | long-term heat resistance | ∘ | ∘ | ∘ | ∘ | ∘ | ∘ | ∘ | ∘ |
| | (100° C.) | | | | | | | | |

TABLE 2

| | | Example 2 | Example 4 | Example 5 |
|---|---|---|---|---|
| substrate | polyvinyl chloride | 100 | 100 | 100 |
| (parts by mass) | polyester-based | — | — | — |
| | trimellitic acid-based | 50 | 50 | 50 |
| | aliphatic dibasic acid-based | — | — | — |
| | epoxy-based | — | — | — |
| | phthalic acid-based | — | — | — |
| primer layer | natural rubber-based | 100 | 90 | 80 |
| (% by mass) | urethane-based | — | 10 | 20 |
| adhesive layer | natural rubber-based | 10 | 10 | 10 |
| (% by mass) | tackifying resin | 55 | 55 | 55 |
| | acrylic | 30 | 30 | 30 |
| | antioxidant | 5 | 5 | 5 |
| properties | heat discoloration resistance | ∘ | ∘ | ∘ |
| | hydrolysis resistance | ∘ | ∘ | ∘ |
| | movement to back surface | ∘ | ∘ | x |
| | followability | ∘ | ∘ | ∘ |
| | tape strength | ∘ | ∘ | ∘ |
| | long-term heat resistance (80° C.) | ∘ | ∘ | ∘ |
| | long-term heat resistance (100° C.) | ∘ | ∘ | ∘ |

TABLE 3

| | | Example 6 | Example 7 | Example 2 | Example 8 | Example 9 |
|---|---|---|---|---|---|---|
| substrate | polyvinyl chloride | 100 | 100 | 100 | 100 | 100 |
| (parts by | polyester-based | — | — | — | — | — |
| mass) | trimellitic | 30 | 40 | 50 | 70 | 80 |
| | acid-based | | | | | |
| | aliphatic dibasic | — | — | — | — | — |
| | acid-based | | | | | |
| | epoxy-based | — | — | — | — | — |
| | phthalic acid-based | — | — | — | — | — |
| primer layer | natural rubber-based | 100 | 100 | 100 | 100 | 100 |
| (% by mass) | urethane-based | — | — | — | — | — |
| adhesive | natural rubber-based | 10 | 10 | 10 | 10 | 10 |
| layer | tackifying resin | 55 | 55 | 55 | 55 | 55 |
| (% by mass) | acrylic | 30 | 30 | 30 | 30 | 30 |
| | antioxidant | 5 | 5 | 5 | 5 | 5 |
| properties | heat discoloration | ∘ | ∘ | ∘ | ∘ | ∘ |
| | resistance | | | | | |
| | hydrolysis | ∘ | ∘ | ∘ | ∘ | ∘ |
| | resistance | | | | | |
| | movement to back | ∘ | ∘ | ∘ | ∘ | ∘ |
| | surface | | | | | |
| | followability | x | Δ | ∘ | ∘ | ∘ |
| | tape strength | ∘ | ∘ | ∘ | Δ | x |
| | long-term heat | ∘ | ∘ | ∘ | ∘ | ∘ |
| | resistance (80° C.) | | | | | |
| | long-term heat | ∘ | ∘ | ∘ | ∘ | ∘ |
| | resistance (100° C.) | | | | | |

TABLE 4

| | | Example 2 | Example 10 | Example 11 | Example 12 |
|---|---|---|---|---|---|
| substrate | polyvinyl chloride | 100 | 100 | 100 | 100 |
| (parts by | polyester-based | — | — | — | — |
| mass) | trimellinc | 50 | — | — | — |
| | acid-based | | | | |
| | aliphatic dibasic | — | 50 | — | — |
| | acid-based | | | | |
| | epoxy-based | — | — | 50 | — |
| | phthalic acid-based | — | — | — | 50 |
| primer layer | natural | 100 | 100 | 100 | 100 |
| % by mass) | rubber-based | | | | |
| | urethane-based | — | — | — | — |
| adhesive layer | natural | 10 | 10 | 10 | 10 |
| (% by mass) | rubber-based | | | | |
| | tackifying resin | 55 | 55 | 55 | 55 |
| | acrylic | 30 | 30 | 30 | 30 |
| | antioxidant | 5 | 5 | 5 | 5 |
| properties | heat discoloration | ∘ | ∘ | ∘ | ∘ |
| | resistance | ∘ | ∘ | ∘ | ∘ |
| | hydrolysis | ∘ | ∘ | ∘ | ∘ |
| | resistance | | | | |
| | movement to back | ∘ | ∘ | ∘ | ∘ |
| | surface | | | | |
| | followability | ∘ | ∘ | x | ∘ |
| | tape strength | ∘ | ∘ | ∘ | ∘ |
| | long-term heat | ∘ | ∘ | ∘ | ∘ |
| | resistance (80° C.) | | | | |
| | long-term heat | ∘ | ∘ | ∘ | x |
| | resistance (100° C.) | | | | |

As shown in Tables 1 to 4, the evaluation results showed that each of the polyvinyl chloride adhesive tapes of Comparative Examples 1 to 5 was poor (x) in at least one of the heat discoloration resistance and the hydrolysis resistance. One may consider that the reason for the poor performance was that the polyvinyl chloride adhesive tapes of Comparative Examples 1 to 5 used the polyester-based plasticizer or contained 10% by mass or less of the acrylic polymer in the adhesive layer. Meanwhile, the evaluation results showed that each of the polyvinyl chloride adhesive tapes of Examples 1 to 12 was excellent (∘) in both the heat discoloration resistance and the hydrolysis resistance.

As shown in Table 2, the movement to the back surface was able to be inhibited by the primer layer in which the content of the natural rubber was 90% by MSS or more.

As shown in Table 3, the followability was able to be improved by the substrate in which the content of the trimellitic acid-based plasticizer was 40 parts by mass. The followability was able to be more improved by the substrate in which the content of the trimellitic acid-based plasticizer was 50 parts by mass.

As shown in Table 3, the tape strength was able to be improved by the substrate in which the content of the trimellitic acid-based plasticizer was 70 parts by mass. In addition, the tape strength was able to be more improved by the substrate in which the content of the trimellitic acid-based plasticizer was 50 parts by mass.

As shown in Table 4, the polyvinyl chloride adhesive layers with the excellent followability were able to be obtained by use of the substrate containing the trimellitic acid-based plasticizer, the aliphatic dibasic acid-based plasticizer or the phthalic acid-based plasticizer.

As shown in Table 4, the polyvinyl chloride adhesive layers with the excellent long-term heat resistance were able to be obtained by use of the substrate containing the trimellitic acid-based plasticizer, the aliphatic dibasic acid-based plasticizer or the epoxy-based plasticizer. Incidentally, even the use of the phthalic acid-based plasticizer made the polyvinyl chloride adhesive layers excellent in the long-term heat resistance at 80° C.

Although the present invention has been discussed using the examples, the present invention is not limited to these examples, and can be variously modified within the scope of the gist of the present invention.

What is claimed is:

1. A polyvinyl chloride adhesive tape comprising:
a substrate containing a polyvinyl chloride and at least one plasticizer selected from the group consisting of trimellitic acid-based plasticizers, aliphatic dibasic acid-based plasticizers, epoxy-based plasticizers, phthalic acid-based plasticizers, pyromellitic acid ester-based plasticizers, phosphate ester-based plasticizers, and ether ester-based plasticizers;
a primer layer disposed under the substrate; and
an adhesive layer disposed under the primer layer, and containing a resin component having 20% by mass or more of acrylic polymer.

2. The polyvinyl chloride adhesive tape according to claim 1, wherein
the primer layer contains a resin component having 90% by mass or more of natural rubber.

3. The polyvinyl chloride adhesive tape according to claim 1, wherein
the substrate contain 40 to 70 parts by mass, inclusive, of the plasticizer relative to 100 parts by mass of the polyvinyl chloride.

4. A wire harness comprising the polyvinyl chloride adhesive tape according to claim 1.
